(19) United States
(12) Patent Application Publication
(10) Pub. No.: US 2026/0274704 A1
(43) Pub. Date: Sep. 17, 2026

(54) PROCESS FOR PRODUCING IRON CHLORIDE FROM IRON PHOSPHATE COMPOUNDS

(71) Applicant: LANXESS Deutschland GmbH, Cologne (DE)

(72) Inventor: Matthias Boll, Cologne (DE)

(73) Assignee: LANXESS Deutschland GmbH, Cologne (DE)

(21) Appl. No.: 19/168,508

(22) PCT Filed: Mar. 22, 2024
(86) PCT No.: PCT/EP2024/057840

§ 371 Date: Sep. 24, 2025

(30) Foreign Application Priority Data
Mar. 28, 2023 (EP) 23164737.1

(51) Int. Cl. C01G 49/10

(52) U.S. Cl. CPC C01G 49/10

(57) ABSTRACT

Process for producing iron chloride, characterized in that it comprises
i) reacting a material containing at least one iron phosphate compound with at least one alkali metal chloride and/or at least one alkaline earth metal chloride at a temperature of 200° C. to 1100° C. in an inert gas atmosphere and
ii) withdrawing and isolating the formed iron chloride in the offgas stream.

The invention relates to a process for producing iron chloride from material containing iron phosphate compounds.

Iron chlorides such as Fe(II)Cl₂ and Fe(III)Cl₃ are typically produced from metallic iron. However, iron-containing compounds that have not hitherto been considered as alternative sources for the production of iron chlorides are becoming available in increasingly large volumes. Examples include lithium iron phosphate (LFP) and lithium iron manganese phosphate (LFMP) as well as well as modifications thereof doped with further elements, in particular metals, employed as cathode materials—also known as cathode active materials (CAM)—for batteries. There is a recycling demand for these after their lifecycle, and they are therefore suitable as an attractive iron raw material source.

Synthetic iron phosphate compounds such as LFP and LFMP therefore have in common that they contain iron phosphate compounds which are available as further avenues to producing iron chlorides.

It is accordingly an object of the invention to provide an appropriate process proceeding from iron phosphate compounds.

The present inventors have surprisingly found a process for producing iron chlorides which is characterized in that it comprises
i) reacting a material containing at least one iron phosphate compound with at least one alkali metal chloride and/or at least one alkaline earth metal chloride at a temperature of 200° C. to 1100° C. in an inert gas atmosphere preferably containing less than 200 ppm, in particular less than 100 ppm, of oxygen and
ii) withdrawing and isolating the formed iron chloride in the offgas stream.

### Iron Phosphate Compounds

Suitable iron phosphate compounds include for example iron phosphates, in particular iron(II) phosphate, iron(III) phosphate and iron(III) pyrophosphatase, lithium iron phosphates (LFP) such as triphyline or lithium iron manganese phosphates (LFMP) which may altogether also be described by the general formula LiFe₍₁₋ₓ₎MnₓPO₄, wherein 0≤x<0.9.

The iron phosphates may be present in anhydrous form or as hydrous iron phosphates, wherein the latter include for example vivianite, generally describable by the formula Fe₃(PO₄)₂·8H₂O, metavivianite, generally describable by the formula Fe₂(PO₄)₂(OH)₂·6H₂O, strengite, generally describable by the formula Fe(PO₄)·2H₂O, Kryzhanovskite, generally describable by the formula Fe₃(OH)₃(PO₄)₂ and phosphoferrite, generally describable by the formula Fe₃(H₂O)₃(PO₄)₂.

It will be appreciated that these iron phosphate compounds may also be employed in any desired mixtures.

Preferred iron phosphate compounds are LFP and/or LFMP having the common general formula LiFe₍₁₋ₓ₎MnₓPO₄, wherein 0≤x<0.9, in particular 0≤x<0.6.

### Material

The material containing at least one iron phosphate compound may consist of 100% iron phosphate compounds but typically contains only proportions thereof. It is preferable when the employed material contains the iron phosphate compounds in an amount summing to 1% to 40% by weight, preferably 1% to 15% by weight.

The employed material contains at least one iron phosphate compound selected from the group consisting of iron phosphates, in particular iron(II) phosphate, iron(III) phosphate and iron(III) pyrophosphate, lithium iron phosphate (LFP), lithium iron manganese phosphate (LFMP), in particular LFP and/or LFMP having the common general formula LiFe₍₁₋ₓ₎MnₓPO₄, wherein 0≤x<0.9, in particular 0≤x<0.6, or mixtures thereof.

An LFP- and/or LFMP-containing material is preferred. As such the process according to the invention especially employs a material containing a proportion of 5% to 100% by weight, preferably 40% to 99% by weight, in particular 50% to 99% by weight, particularly preferably of 70% to 99% by weight, of LFP and/or LFMP.

It is preferably also possible to describe the composition of the employed material via determination of the weight fraction of certain elements in the employed preferably LFP- and/or LFMP-containing material, in each case based on the amount of material, wherein the employed material preferably contains:
1% to 36% by weight of Fe, preferably 2% to 100% by weight thereof as an iron phosphate compound,
1% to 20% by weight of P,
0% to 35% by weight of Mn,
1 to 8% by weight of Li and
1% to 55% by weight, preferably 1% to 40% by weight, in particular 1% to 30% by weight, of carbon.

These reported amounts of the elements may derive firstly from the LFP or the LFMP but also from the other constituents of the employed material, such as for example from residues of metallic constituents. The elemental contents are preferably determined via the conventional methods of elemental analysis. The type and amount of the iron phosphate compound present is preferably determined by the method of X-ray scattering XRD on a powder in reflection with Cu—K_{α} radiation. The obtained reflections are compared for example with data from the ICDD (International Centre for Diffraction Data) and assigned to the obtained iron phosphate-containing phases. For lithium iron phosphate the reflections of the JCPDS (International Centre for Powder Diffraction Data Sample) Card #83-2092 are used for comparison here.

The employed material preferably further contains 1% to 55% by weight, preferably 1% to 40% by weight, in particular 1% to 30% by weight, of carbon, especially graphite and/or carbon black.

It is preferable when the sum of LFP and/or LFMP and carbon in the employed preferably LFP- and/or LFMP-containing material is more than 70% by weight, preferably more than 80% by weight, particularly preferably more than 90% by weight.

The LFP- and/or LFMP-containing battery cells are typically mechanically broken up as far as possible and the remainder containing the cathode and anode material, optionally binders and further constituents comminuted to afford a mass, which is black in colour on account of the dark LFP/LFMP and the graphite-containing anode material and is therefore known as “black mass”.

As a consequence of technically incomplete separation the black mass may also contain residues of other battery constituents, for example metals.

The material may therefore also be the so-called black mass having a proportion of iron phosphate compounds of 5% to 90% by weight.

The employed material may also contain metals, preferably from 0% to 15% by weight, preferably 0% to 5% by weight, in particular Al, Cu, Co and Ni.

The aluminium content, determined as elemental aluminium, in the employed material is preferably less than 10% by weight, in particular less than 5% by weight.

It is preferable when the employed material contains preferably less than 10% by weight, especially less than 1% by weight, particularly preferably less than 0.1% by weight, of polymer particles, especially plastic such as polyethylene and/or polypropylene.

It is also preferable when the material used contains less than 5% by weight of PVDF (polyvinylidene fluoride) and/or other binders, for example, carboxymethylcellulose and/or alginates. The content of all binders is preferably less than 5% by weight.

The VOC content of the material used is preferably less than 1% by weight, especially less than 0.1% by weight, particularly preferably less than 0.01% by weight. VOCs (volatile organic compounds) are preferably understood to mean organic compounds having boiling points in the range from 50 to 260° C., at a standard pressure of 101.3 kPa.

The employed LFP- and/or LFMP-containing material is preferably black mass from battery comminution.

The employed material preferably has an average particle size of 0.1 μm to 10 mm. Depending on dimensions, the particle size may be determined simply by sieving or for smaller particles by the method of laser diffraction or laser scattering. The best method to be used in each case is known to the person skilled in the art.

The employed preferably LFP- and/or LFMP-containing material may also be a coated material. Coating materials preferably include carbon, especially graphite, and metal oxides.

### Alkali Metal Chlorides

Suitable alkali metal chlorides preferably include NaCl, KCl, LiCl and mixtures thereof. Preference is given to NaCl or KCl or a mixture of NaCl and KCl. If NaCl is used in admixture with other alkali metal chlorides, in particular with KCl, the mixture weight ratio is preferably from 10:1 to 0.1:1, in particular from 5:1 to 0.5:1.

Alkali metal chloride is preferably employed in an amount of 1 to 5 mol, in each case based on 1 mol of iron present as determined by elemental analysis.

### Alkaline Earth Metal Chlorides

Suitable alkaline earth metal chlorides especially include MgCl₂, CaCl₂ or mixtures thereof. MgCl₂ is preferred.

Preference is given to a mixture of alkaline earth metal chlorides and alkali metal chlorides, in particular MgCl₂ and NaCl and/or KCl in a weight ratio of 4:1 to 0.25:1, in particular from 2:1 to 1:2. It is particularly preferable to employ a mixture of KCl, NaCl and MgCl₂.

It is likewise particularly preferable to employ a mixture of MgCl₂ and KCl in a weight ratio of 3:1 to 0.5:1.

### Miscellaneous

Particular preference is given to a molar ratio of chlorine from the employed alkali metal chlorides and alkaline earth metal chlorides to phosphate groups present in the material in the range from 1:1 to 4:1, preferably from 2.3:1 to 3.5:1 mol/mol.

### Process

The input materials, the material and the alkali metal chloride and/or alkaline earth metal chloride to be employed, are preferably mixed in a mixer in dry form. Preferably employed mixers are a paddle mixer or else mills, for instance a ball mill. The latter have the advantage of also achieving better homogenization of the employed reactants through comminution.

It is advantageous to already carry out the mixing step of the reactants in an inert gas atmosphere, preferably anhydrous, in order to protect the possibly present hygroscopic components from water absorption, which could adversely affect the process yield.

The reaction itself is preferably also carried out in the absence of air and water. Preferred inert gases preferably include nitrogen, argon or carbon dioxide. It is preferable when the inert gas atmosphere contains less than 200 ppm, in particular less than 100 ppm, of oxygen

The reaction of the iron phosphate compounds may then be performed in a fluidized bed or dumped bed or moving bed reactor, in a shaft furnace or in a preferably gas-tight furnace, such as may be conceived most simply as an indirectly heated tube furnace or rotary furnace. The material may optionally be shaped before introduction of the material into a furnace, for example by briquetting, extrusion or pelletizing, optionally with subsequent thermal pretreatment at 100° C. to 199° C.

Auxiliaries such as phyllosilicates, in particular bentonites, and lignosulfonate, methylcellulose, waterglass, starch or others may be used to this end. The products formed in the reaction which are volatile at the reaction temperature, here especially iron chloride, but also aluminium chlorides and optionally further heavy metal chlorides, are preferably resublimed and collected together at a cold spot at temperatures below 150° C. or resublimed and collected separately at different cold spots.

Preferred separation temperatures for FeCl₂ are not more than 700° C., preferably not more than 600° C. In the case of iron(III) chloride the temperature for resublimation may also be less than 307° C.

Iron(III) chloride and also AlCl₃, if aluminium is present in the employed material, may be separated out of the offgas stream, preferably by resublimation on cooled surfaces having different temperatures, and separated from one another. If the iron(III) chloride is present in the offgas stream together with AlCl₃ the respective chlorides, due to their sufficiently different boiling points, can also be fractionally resublimed on different surfaces having different temperatures and hence separated very cleanly.

Preferred deposition temperatures are less than 700° C., in particular less than 699° C. to 307° C., for FeCl₂, less than 307° C., in particular 150° C. to 300° C., for FeCl₃ and less than 150° C., in particular 110° C. to 149° C., for AlCl₃.

The iron recovered according to the invention in the form of iron(III) chloride and/or iron(II) chloride is already very pure and may be converted into the desired raw material form of iron, for example for new production of LFP and/or LFMP. Examples here include iron sulfate, iron nitrate, iron phosphate, or the wide variety of different forms of iron oxide.

Alternatively, the iron chloride, even without having been deposited by resublimation, may be introduced directly as a gas stream into an aqueous medium containing sulfuric acid, nitric acid or phosphoric acid and thus made to form corresponding iron(III) sulfates, nitrates or phosphates. Concomitant use of a suitable reducing agent in the reaction is also possible to obtain an iron(II) sulfate, iron(II) nitrate or iron(II) phosphate.

However, it is preferable to separate iron chloride from the offgas stream by resublimation.

The offgas stream contains not only gaseous iron chloride, such as iron(III) chloride or iron(II) chloride, and optionally also AlCl₃ if aluminium is present in the employed material but also optionally NaCl and optionally volatile chlorides of further metals if these metals were present in the black mass.

The residue after reaction preferably contains phosphates of the employed alkali metal and/or alkaline earth metal group.

The lithium ions present in the residue may be extracted by shaking out the dry residue with a suitable non-aqueous solvent. These suitable solvents include alcohols, esters or ethers, ketones or nitriles or mixtures thereof, optionally also in mixtures with water.

The preferably lithium-depleted to lithium-free residue obtained after extraction is preferably treated by adding 0.1 to 5 mol of phosphoric acid per mol of phosphate, preferably 0.2 to 1 mol of phosphoric acid per mol of phosphate, of the residue. The residue of the reaction may thus be converted into a soluble form in which it is suitable as such for use in agriculture.

The insoluble residue that remains is preferably carbon if this was present in the employed material. The remaining water-soluble constituents may then, optionally after their possible existence has been ascertained by the conventional H₂S separation sequence, be separated from one another in the form of their sulfides, chlorides, phosphates, fluorides or other precipitation compounds and isolated.

### Temperature

The reaction is preferably carried out at a temperature of 400° C. to 900° C. The reaction typically takes 5 minutes to 10 hours, preferably 2 to 5 hours.

If the employed material has a binder content of greater than 1% by weight based on the material, a leaching is preferably effected by a treatment with organic solvent, especially acetone, ethyl acetate, methyl ethyl ketone, tetrahydrofuran (THF), ethyl acetoacetate, acetylacetone, dioxane and/or acetic anhydride and mixtures thereof, to reduce the content to less than 0.1% by weight.

If the material contains a polymer content, especially plastic, of greater than 1% by weight, it is advantageous first to subject the material to a thermal treatment at a temperature of 300° C. to 600° C., preferably under inert gas, to reduce the polymer content to less than 0.1% by weight. Aside from a leaching with organic solvents a possible binder content of greater than 1% may alternatively or in addition likewise be reduced to less than 0.1% by weight by a thermal treatment at a temperature of 300° C. to 700° C., preferably under inert gas.

### Reactor

The material to be used in the process according to the invention is preferably introduced into a reactor that has preferably been provided with a layer which is resistant under the reaction conditions to be established. Preferred reactor materials are nickel- or graphite-coated reactors. Reactors used may include tubular reactors such as rotary tube reactors or other reactors. Particular preference is given to reactors which allow movement of material during the reaction. Preference is given to fluidized bed apparatuses and rotary tube reactors, or a reaction in an extruder apparatus with screw propulsion.

In the case of a tubular reactor, the reactor length is preferably 0.2 to 40 m. The residence time in the reactor during the reaction generally depends on the temperature. The residence time in the reactor may extend, for example, from one minute to 5 hours. The process according to the invention may be conducted batchwise or continuously.

There is preferably an outlet for the offgas stream in the reactor. The offgas stream comprises the gaseous reaction products and volatile constituents of the material which may be withdrawn from the reaction space together. Possible separation of solid constituents such as fine dust from gaseous constituents of the offgas stream may be effected by apparatuses such as a cyclone for example.

The reaction is preferably terminated when the proportion of iron in the residue has reached less than 0.05% by weight.

Preferred deposition temperatures for FeCl₂ are less than 700° C., for FeCl₃ are not more than 307° C., in particular 150° C. to 300° C., and for AlCl₃ are not more than 150° C., in particular 110° C. to 149° C.

The sparingly soluble manganese sulfide that remains after an H₂S separation sequence may be reacted with air to afford manganese sulfate and thus recovered and optionally reused for production of LFMP.

### EXAMPLES

### Analytical

After dissolution of the LFF sample LFP or the sublimate with suitable acids analysis was carried out in an ICP-OES instrument after calibration for the respective element via standard solutions.

X-ray diffractograms (XRD) were recorded on powders (flatmount) between 2 theta angles of 0° and 60° at a wavelength of 0.154 nm.

### Example 1: LFP NaCl/MgCl₂

5.02 g of lithium iron phosphate (31.7 mmol of phosphate) (lithium iron phosphate, structure confirmed by XRD; no further reflections detected except those from lithium iron phosphate), having the following analytical data (in % by weight): Fe 34.6%, phosphate 60.9%, Li 4.6%, C: 1.8%, having the average particle size distribution d10 0.35 μm, d50 0.62 μm, d100 6.7 μm is intimately mixed and homogenized with 1.83 g of NaCl (31.3 mmol chloride) and 2.24 g of anhydrous MgCl₂ (47 mmol chloride) and placed in a quartz glass tube (diameter: 120 mm) in a tubular furnace.

A stream of dry nitrogen (0.3 litres per minute; oxygen content <100 ppm v/v) is passed through the reactor and heated to 750° C. and held at this temperature for six hours. A brown precipitate (1.17 g) is deposited on the cooler quartz tube projecting from the furnace at about 160° C. The precipitate comprises 82% by weight of a mixture of iron(II) chloride and iron(III) chloride and 15% by weight of NaCl. Reducing the reaction temperature makes it possible to reduce the proportion of NaCl.

The weight loss of the sample is 34% by weight. The residue contains markedly less iron than the reactant and is therefore lighter in colour.

The residue is taken up in 50 ml of anhydrous ethanol and then filtered. The procedure is repeated twice. The filtrates are combined and the ethanol evaporated. The remaining mass contains the lithium compounds.

The residue remaining after ethanol extraction was first dried and then mixed with concentrated phosphoric acid. The obtained soluble phosphate has a very low iron content and may therefore be used as plant fertilizer.

### Example 2: LFP KCl/MgCl₂

5 g of lithium iron phosphate (31.7 mmol of phosphate) (lithium iron phosphate, structure confirmed by XRD, no further reflections detected except those from lithium iron phosphate), having the following analytical data (in % by weight): Fe 34.6%, phosphate 60.9%, Li 4.6%, C: 1.8%, having the average particle size distribution d10 0.35 μm, d50 0.62 μm, d100 6.7 μm is intimately mixed and homogenized with 3 g of KCl (40 mmol chloride) and 2 g of anhydrous MgCl₂ (42 mmol chloride) and placed in a quartz glass tube (diameter: 120 mm) in a tubular furnace.

A stream of dry nitrogen (0.3 litres per minute; oxygen content <100 ppm v/v) is passed through the reactor and heated to 750° C. and held at this temperature for twelve hours. A brown precipitate (3.4 g) is deposited on the cooler quartz tube projecting from the furnace at about 160° C. The precipitate comprises a mixture of iron(II) chloride and iron(III) chloride.

The weight loss of the sample is 45% by weight and the residue is much lighter in colour than the reactant.

The residue is taken up in 200 ml of anhydrous ethanol and then filtered. The procedure is repeated twice. The filtrates are combined and the ethanol evaporated. The remaining mass contains the lithium compounds.

The residue remaining after ethanol extraction was first dried and then mixed with concentrated phosphoric acid. The obtained soluble phosphate has a very low iron content and may therefore be used as plant fertilizer.

1. A process for producing iron chloride, the process comprises
i) reacting a material containing at least one iron phosphate compound with at least one alkali metal chloride and/or at least one alkaline earth metal chloride at a temperature of 200° C. to 1100° C. in an inert gas atmosphere and
ii) withdrawing and isolating the formed iron chloride in the offgas stream.

2. The process according to claim 1, wherein the iron chloride is deposited from the offgas stream by resublimation in step ii).

3. The process according to claim 1, wherein the iron chloride is deposited at temperatures of less than 700° C., for FeCl₂ and at temperatures of less than 307° C. for FeCl₃.

4. The process according to claim 1, wherein the employed material contains at least one iron phosphate compound selected from the group consisting of iron phosphates, iron(II) phosphate, iron(III) phosphate and iron(III) pyrophosphate, lithium iron phosphate (LFP), lithium iron manganese phosphate (LFMP), LFP and/or LFMP having the common general formula LiFe₍₁₋ₓ₎MnₓPO₄, wherein 0≤x<0.9, or mixtures thereof.

5. The process according to claim 1, wherein the reaction is carried out with at least one alkali metal chloride and at least one alkaline earth metal chloride.

6. The process according to claim 1, wherein the reaction is carried out with sodium chloride and magnesium chloride or potassium chloride and magnesium chloride.

7. The process according to claim 1, wherein it employs a mixture of alkaline earth metal chlorides and alkali metal chlorides in a weight ratio of 4:1 to 0.25:1.

8. The process according to claim 1, wherein the employed material contains
1% to 36% by weight of Fe as an iron phosphate compound,
1% to 20% by weight of P,
0% to 35% by weight of Mn,
1 to 8% by weight of Li and
1% to 55% by weight of carbon.

9. The process according to claim 1, wherein the employed material contains from 5% to 100% by weight, of iron phosphate compound.

10. The process according to claim 1, wherein the molar ratio of chlorine from the employed alkali metal chlorides and alkaline earth metal chlorides to phosphate groups present in the material is in the range from 1:1 to 4:1 mol/mol.

11. The process according to claim 1, wherein the reaction is carried out at a temperature of 400° C. to 1000° C.
